(19) United States
(12) Patent Application Publication
(10) Pub. No.: US 2025/0249626 A1
(43) Pub. Date: Aug. 7, 2025

(54) STAMPING TOOL WITH MULTIPLE MOVEMENTS

(71) Applicant: DAHER AEROSPACE, ORLY (FR)

(72) Inventors: Antoine GUERNIC, Saint Philbert de Bouaine (FR); Rémi JOUTEUX, COUERON (FR)

(73) Assignee: DAHER AEROSPACE, ORLY (FR)

(21) Appl. No.: 18/854,535

(22) PCT Filed: Apr. 11, 2023
(86) PCT No.: PCT/EP2023/059460

§ 371 Date: Oct. 6, 2024

(30) Foreign Application Priority Data
Apr. 11, 2022 (FR) FR2203323

(51) Int. Cl. B29C 43/36; B29C 43/42; B29C 70/46; B29L 31/30

(52) U.S. Cl. CPC B29C 43/361; B29C 43/42; B29C 70/461; B29C 2043/3613; B29C 2043/425; B29L 2031/3085

(57) ABSTRACT

The invention relates to a tooling for stamping a composite blank with a thermoplastic matrix and continuous fibrous reinforcement, and a stamping method using such a tooling, the tooling comprising:
a die comprising an imprint (110) having a bottom (111) and side walls (112);
a punch (120) the external shape of which is paired with the imprint of the die and comprising a central part (123) and at least two lateral movable parts (121, 122) in sliding connection with the central part (123), so that the movable lateral parts being stopped in translation according to a striking direction (190) against the bottom of the die, a further displacement of the central part (123) in the same direction causes the movable lateral parts to move in translations perpendicular to the striking direction (190).

### TECHNICAL FIELD

The invention belongs to the field of tooling, more particularly to the field of stamping tools used for shaping thermoplastic matrix composite materials.

More precisely, the invention relates to a stamping tooling comprising mobilities and specifically multiple mobilities.

### BACKGROUND ART

Stamping is a shaping method consisting in deforming a blank into a three-dimensional shape between a punch and a die of complementary shapes separated by an airgap, the latter corresponding to the thickness of the part thus made.

Such a shaping is carried out by a relative translation movement of the punch being brought closer to the die and penetrating inside it, thus urging the blank initially closing the entry plane the imprint of the die and being held in the airgap between the die and the punch, to be deformed so as to reproduce the shapes of the punch and the die during the penetration of the punch in the die.

Usually, the tooling is set up on a press, the die being fixed, and the punch being attached to the ram of the press, the strike being performed by a vertical translation.

The tooling is said to comprise mobilities when it comprises elements configured to moving in a manner different from the striking movement during the stamping. These elements may be located on the punch or on the die, but overall are rather located on the punch.

According to nonrestrictive examples of such mobilities, these elements are moving during a strike in a direction comprising a component perpendicular to the striking direction or are moving in the striking direction but at a moving rate different or even opposite to the striking rate.

These mobilities can be controlled by electric, pneumatic or hydraulic effectors or be generated by appropriate mechanical connections driven by the striking movement itself.

Document EP 2 243 617 discloses an example of such a tooling, comprising such mobilities and adapted for stamping a blank made of a composite material with a thermoplastic matrix, comprising a component movable in a direction perpendicular to the striking direction and adapted to carry out a bending operation.

Tools with mobilities are particularly adapted for making parts with flanged edges out of a composite blank comprising a continuous fibrous reinforcement made of fibers with none or very little plasticity such as carbon fibers or glass fibers.

As a matter of fact, the deformation of such a blank occurs by interlaminar and inter-fiber slipping i.e. by local modifications of the distance between fibers within acceptable limits.

Thus, to be shaped, such a blank shall be brought to a temperature high enough, generally equal or higher to the melting temperature of polymer making the matrix of the composite, so that this polymer does not hinder the interlaminar and inter-fiber slipping of reinforcing fibers.

In a nutshell, stamping of a composite blank comprising a thermoplastic matrix reinforced by continuous fibers with no plasticity, implies to set this blank, by heating, in a state where the cohesion of the blank is loose. The cohesion is restored at the end of the stamping operation by the compaction of the material between the walls of the punch and those of the die, so that when the final part comprises at least two flanged edges, a mobility is required to obtain at the same time the shaping of the blank and subsequently the compaction of the flanged edges.

Controlling the compaction phase at the end of the stamping operation is essential because it shall enable at the same time, to remove the voids in the lamination while avoiding inter-fiber squeezing, since too severe a compaction tends to squeeze out of the polymer from inbetween the fibers. Consequently, the ability to control thicknesses in a tool with mobilities is essential.

Document EP 1 543 942 discloses another example of a tooling with mobilities for stamping a composite blank with a thermoplastic matrix and a continuous fibrous reinforcement, in particular for making a part with flanged edges in the shape of a half-box.

This device of the prior art comprises a punch, comprising movable lateral parts connected to the punch by elastic connections, the aforementioned lateral parts being adapted to deviate from a central part of the punch, the central part comprising a wedge shape portion connected to the punch and vertically movable relative to the lateral parts when, during the stamping operation the punch reaches the bottom of the die, the relative displacement of the wedge shaped portion causing the lateral parts to space apart each other, thus achieving the compaction of the flanged edges of the half-box shaped part.

The kinematics of this device of the prior art make the lateral parts moving according to a swiveling movement under the effect of the wedge-shaped part displacement. The swiveling occurring around a point close to the bottom of the die, on the one hand the compaction pressure is not uniform over the depth of the flanged edges, moreover, the kinematics of this device do not allow to make a part comprising pinched flanged edges, i.e. when the distance between two flanged edges decreases from the bottom of the die to the entry plane of the die.

However, such parts, with a half-box shape and pinched flanged edges, are common in aeronautics for example for wing ribs.

Moreover, this mobility mechanism of the prior art does not allow a precise adjustment of the degree of compaction achieved by these mobilities and of the pairing of the punch with the die.

Document FR2717735 discloses a tooling comprising lateral pressing means for the consolidation of a half-box shaped part. This tooling is not adapted for the stamping a consolidated composite thermoplastic blank.

Similarly, document DE741682 discloses a tooling for a consolidation in shape, the technical solution of which is not applicable to the stamping of a consolidated composite blank.

### SUMMARY OF THE INVENTION

The tooling and method described below aim at solving the deficiencies described above and for this purpose concern a stamping tool comprising:
a press comprising a fixed platen and a moving platen connected to a ram for moving the moving platen towards the fixed platen according to a striking direction;
a die adapted to be fixed on the fixed platen of the press, comprising an imprint comprising a bottom and side walls an entry width;
a punch capable of being mounted on the moving platen of the press, the external shape of which is paired with the imprint and comprising a central part and at least two movable lateral parts in sliding connection with the central part, the central part comprising an end located between the at least two movable lateral parts and forming a wedge between the at least two lateral parts,
pressure means acting on the at least two movable lateral parts to urge them against the central part, so that a width of the punch is less than the entry width;
so that the at least two movable lateral parts being stopped in translation in the striking direction against the bottom of the imprint, a further displacement of the central portion in the striking direction relative to the at least two movable lateral parts causes the displacement of at least two movable lateral parts relative to each other in a translation towards the side walls of the imprint, perpendicular to the striking direction, achieving a first lateral expansion of the punch in a direction of expansion towards the side walls of the imprint and that the width of the expanding punch is equal to or greater than the entry width.

Thus, the side expansion of the punch is carried out by a kinematics of translation of the lateral parts, which enables, on one hand, a uniform compaction of the flanged edges of the part comprised between these lateral parts and the side walls of the imprint of the die, and, on the other hand, makes it possible for the punch stamp a part comprising strongly pinched flanged edges.

The tooling may be implemented according to the embodiments and variants exposed hereafter, which are to be considered individually or according to any technically operative combination.

Advantageously, the central part of the punch may comprise a shoulder making an abutment at its end located between the at least two lateral movable parts, the at least two lateral movable parts being stopped in translation in the striking direction relative to the central part and urged against the shoulder by at least one spring acting on the at least two lateral movable parts in the striking direction between the at least two lateral movable parts and the moving platen of the press. This set up makes it possible to retract the expansion of the punch and to bring it up back after the strike even if the part comprises strongly pinched flanged edges.

According to an embodiment, the punch may comprise two additional lateral parts in sliding connection with a wedge shape portion of the central part between the two additional lateral parts, adapted to provide a second side expansion direction of the punch, the second side expansion direction being perpendicular to the first expansion direction. This embodiment is adapted for the making by stamping of a half-box shaped part comprising 4 flanged edges.

Advantageously, the wedged shape central part of the punch may comprise two portions and means between these two portions for adjusting a width of the punch. according to the expansion direction. This embodiment allows a precise pairing of the punch with mobilities, with respect to the die imprint and a precise adjustment of the thickness of the parts obtained by stamping by means of such a tooling.

The tooling may be used in a method for making a part comprising a web with a web thickness and at least two flanged edges, each having a flanged edge thickness, at least one of the at least two flanged edges being oriented with respect to the web at an angle of less than 90°, the method comprising steps of:
pairing the punch with the imprint of the matrix by means to adjust the width of the central part of the punch according to the thickness of the web and the thicknesses of the flanged edges;
obtaining a composite blank comprising a thermoplastic polymer matrix and continuous fibrous reinforcements whose one width is greater than the entry width;
heating the composite blank to a temperature equal to or greater than a melting temperature of the polymer matrix;
positioning the composite blank above the imprint and stamping the composite blank between the punch and the imprint according to a striking stroke of the moving platen until the end of the punch reaches a distance from the bottom of the imprint equal to the thickness of the web;
continuing the striking stroke of the moving platen to move the movable lateral parts of the punch to distances from the side walls of the imprint equal to the thickness of the flanged edges and that a width of the expanding punch is greater than or equal to the entry width so as to compact the part;
cooling down the part under pressure between the punch and the imprint to a temperature below the melting temperature of the polymer matrix to consolidate the part; and
moving the moving platen in the opposite direction and unmolding the part.

This method makes it possible to manufacture in series and in an economic way composite structural parts of high quality and high structural performance with respect to their mass, in particular wing ribs for an aircraft, the ribs comprising pinched flanged edges.

### BRIEF DESCRIPTION OF THE DRAWINGS

The invention may be implemented according to the non-limiting embodiments and variants exposed hereafter and in reference to [FIG. 1] to [FIG. 6] in which:

FIG. 1

FIG. 1 shows in a simplified cross-sectional view a schematic embodiment of the tooling at the beginning of a stamping stroke;

FIG. 2

FIG. 2 shows according to the same cross-sectional view as [FIG. 1], the tooling at the end of the stamping stroke;

FIG. 3

FIG. 3 is a perspective view of an exemplary embodiment of a punch comprising lateral parts movable in two intersecting directions;

FIG. 4

FIG. 4 shows the punch of [FIG. 3] in a partial perspective exploded view;

FIG. 5

FIG. 5 schematically represents the cross-section of a wing of an aircraft according to a section defined on this same figure;

FIG. 6

FIG. 6 shows a flowchart of an exemplary embodiment of a method implementing the tooling.

### DESCRIPTION OF EMBODIMENTS

Throughout the text, the term “blank” refers to a rigid flat blank, cut to an appropriate contour and intended to be deformed to obtain a three-dimensional part.

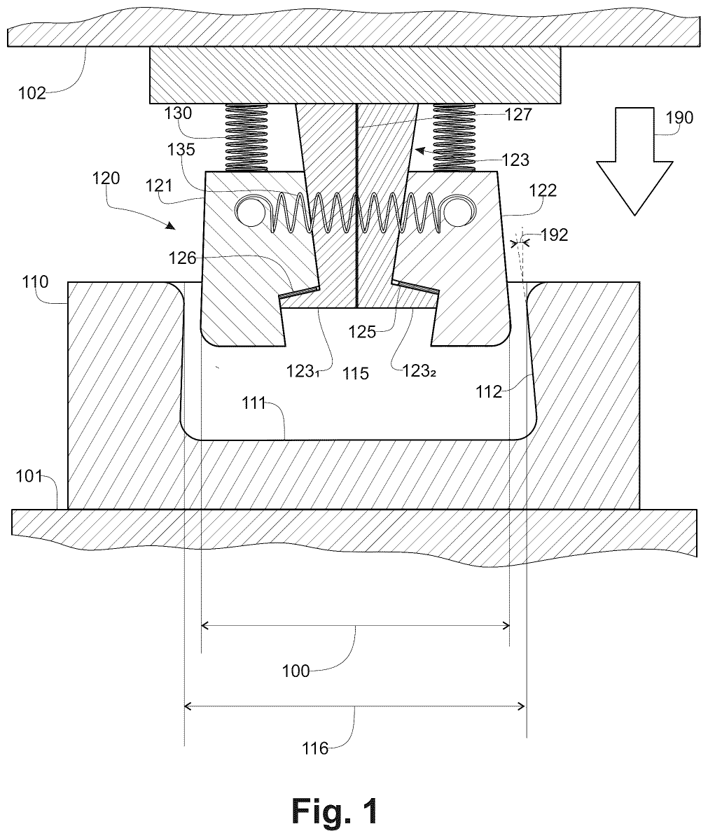

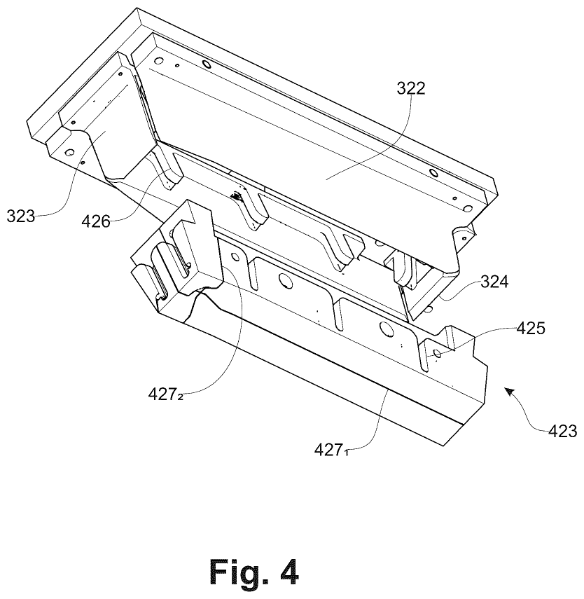

In [FIG. 1] to [FIG. 4], the tooling is represented without the part to be made.

[FIG. 1], according to some embodiment, the tooling comprises a press (not fully shown) comprising a fixed platen (101) and a moving platen (102). The moving platen is configured to be moved towards the fixed platen, for instance by means of a hydraulic cylinder, according to a striking direction (190), so as to carry out a stamping operation.

According to this exemplary embodiment, a forming die (110) comprising an imprint (115), is attached to the fixed platen (101) by appropriate means. The imprint is delimited by a bottom (111) and side walls (112). According to such an embodiment, the side walls (112) of the imprint exhibit a pinch, according to an angle (192) measured with respect to the striking direction (190), so that the width of the imprint is greater at the bottom (111) than at the entrance of the imprint on the opposite face of the forming die.

A punch (120) is attached to the moving platen (102) and moves with it. The punch comprises a central part (123) in the shape of a wedge inserted between movable lateral parts (121, 122).

According to such embodiment, the central part comprises at its end, between the movable lateral parts (121, 122), a portion in shoulder (125) forming an abutment.

The two movable lateral parts (121, 122) are in a slide connection on the central part (123) in the shape of a wedge and are pushed against the shoulder (125) forming an abutment by compression springs (130) acting between the movable lateral parts (121, 122) and the fixed platen (102) of the press.

The position of the abutment made by the shoulder is advantageously adjustable by appropriate means such as peelable shims (126).

According to this embodiment, a traction spring (135) tends to press the movable lateral parts (121, 122) in contact with the wedge-shaped central part (123).

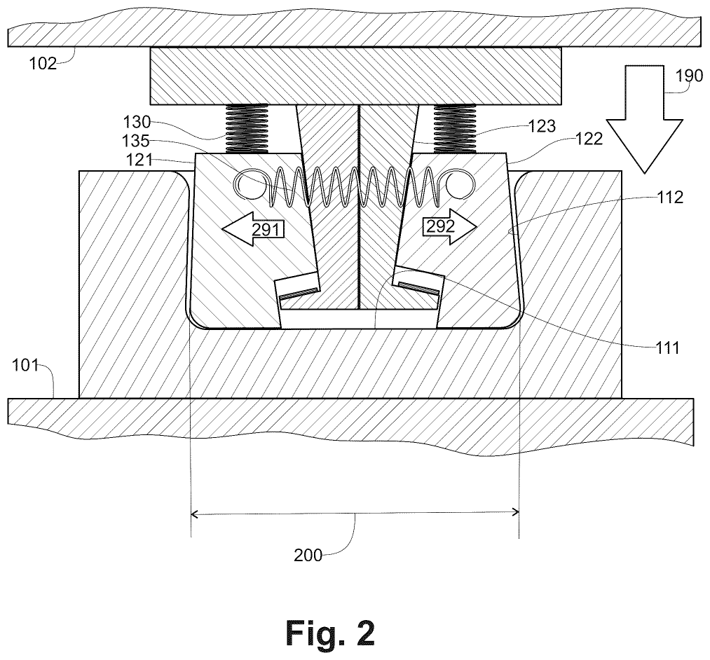

The shapes of the punch (120) and of the imprint (115) are paired so that the punch being inserted into the imprint, an airgap corresponding to the thickness of the part to be made (not shown) is left between the punch and the imprint.

[FIG. 2], the punch (120) descending into the imprint (115), when the ends of the movable lateral parts (121, 122) come into contact with the bottom (111) of the imprint 115), directly in this figure but in practice with the bottom of the part to be made, the latter being comprised between the bottom of the imprint and the end of the punch, if the striking movement (190) is continued, then the central part (123) of the punch moves in the striking direction (190) between and relatively to the movable lateral parts (121, 122). Given the wedge shape of the slide connection between the movable lateral parts (121, 122) and the central part (123) of the punch, this relative displacement produces an expansion of the punch, the movable lateral parts moving in directions (291, 292) perpendicular to the striking direction (190) and approaching the side walls (112) of the imprint, while compressing the compression springs (130) acting on the movable lateral parts in the striking direction.

Thus, the use of this tool makes it possible to compress a thickness of material comprised between the punch and the imprint, and more particularly between the movable lateral parts and the side walls of the imprint, including in connecting areas between the side walls (112) and the bottom (111) of the imprint. This ability of the tool to perform this lateral compression enables the stamping then the consolidation of a composite blank with thermoplastic matrix and continuous fibrous reinforcement, previously brought to a temperature close to the melting temperature of the polymer making its matrix.

Returning to [FIG. 1], in this figure the movable lateral parts (121, 122) of the punch are brought closer together so that the width (100) of the punch is less than the entry width (116) of the opening of the imprint and the punch may penetrate inside the imprint even though the side walls of the imprint are pinched.

[FIG. 2], the penetration of the central part (123) of the punch between its movable lateral parts (121, 122) causes the width of the punch to expand so that its width (200), as a result of this expansion, may become larger than the entry width of the imprint.

Thus, the tooling is adapted for stamping a part with flanged edges with a high pinch angle (192) of up to 30°.

At the end of a stamping operation, the moving platen (102) is moved up, away from the fixed platen (101). The compression springs (130) keep on pressing the movable lateral parts (121, 122) of the punch towards the imprint whereas the tension spring (135) presses the movable lateral parts against the central part (123) of the punch, so that the relative displacement of the wedge-shaped central part (123) causes the movable lateral parts to tighten and the punch to shrink enabling it be taken out of the imprint.

[FIG. 2], the wedge-shaped central part is shown with symmetrical slopes so that for a given relative displacement in the striking direction (190) of the central part (123), the movable lateral parts (121, 122) move laterally of a same stroke (291, 292). The skilled person understands that the central part (123) may have asymmetrical slopes so that a given relative displacement of the central part (123) in the striking direction (190) leads to different strokes (291, 292) of the movable part on the right (122) and the movable part on the left (121) in the figure, in order to accommodate a specific part geometry, including different flanged edge pinches on each side.

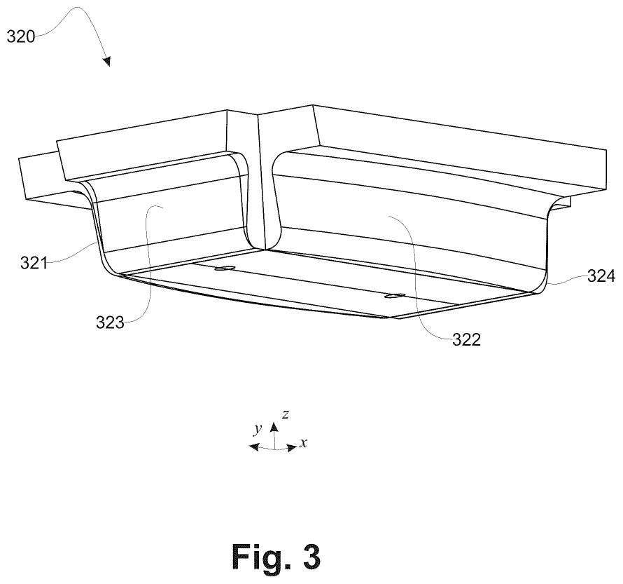

Returning to [FIG. 1], the central part (123) is advantageously made up of two parts (1231, 1232) and comprises means (127), e.g. peelable shims, between said two parts in such a way as to adjust the width of the central part (123) and thus precisely define the airgap between the movable lateral parts and the side walls of the imprint at the end of the punch's stroke as well as the pairing punch with the imprint.

[FIG. 3], according to an exemplary embodiment, the punch (320) may comprise movable lateral parts (321, 322, 323, 324) capable of carrying out an expansion according to intersecting planes. Thus, with reference to the mark x, y, z [FIG. 3], when the punch is lowered, 2 of the movable lateral parts (321, 322) are expanding the punch in a direction y in a plane zy and the other two movable lateral parts (323, 324) are expanding the punch in a direction x in a plane xz.

All the characteristics and embodiments developed above apply both to the movable lateral parts (321, 322) in one plane and to the movable lateral parts (323, 324) in another plane.

The skilled person understands, on the one hand, that the secant planes in which the different expansions are carried out are not necessarily perpendicular and on the other hand, that this embodiment is not limited to a combination of expansions according to only two intersecting planes, but that mobilities can perform in a plurality of intersecting planes.

[FIG. 4], the central part (423) of the tooling may comprise an assembly of several parts, and means (4271, 4272) between these parts for a precise adjustment of the airgaps between the punch and the side walls of the imprint.

According to this exemplary embodiment, the central part (423) and the movable lateral parts (321, 322, 323, 324) are connected by grooves (425) made in the central part (423) which cooperate with tenons (426) on the inner faces of the movable lateral parts. These assemblies ensure the translation stop of the movable lateral parts perpendicular to their respective expansion direction but also the technical functions of the shoulder (125) forming an abutment.

The selection of materials making the various parts of the tooling depends on the nature of the materials constituting the shaped blank and in particular the stamping temperature and thermal expansion characteristics of these materials.

As non-limiting examples, the various parts are made of a carbon tooling steel comprising magnesium chromium and molybdenum, or in an INVAR® steel comprising iron and nickel.

The ability of the tooling to make composite parts with thermoplastic matrix comprising flanged edges by stamping, is advantageously implemented to integrate functions on some parts which can thus be carried out in a single piece while, according to the prior art, these required the assembly of multiple components. By reducing the number of components and the number of assemblies, the manufacturing costs and the weight structural components may be reduced.

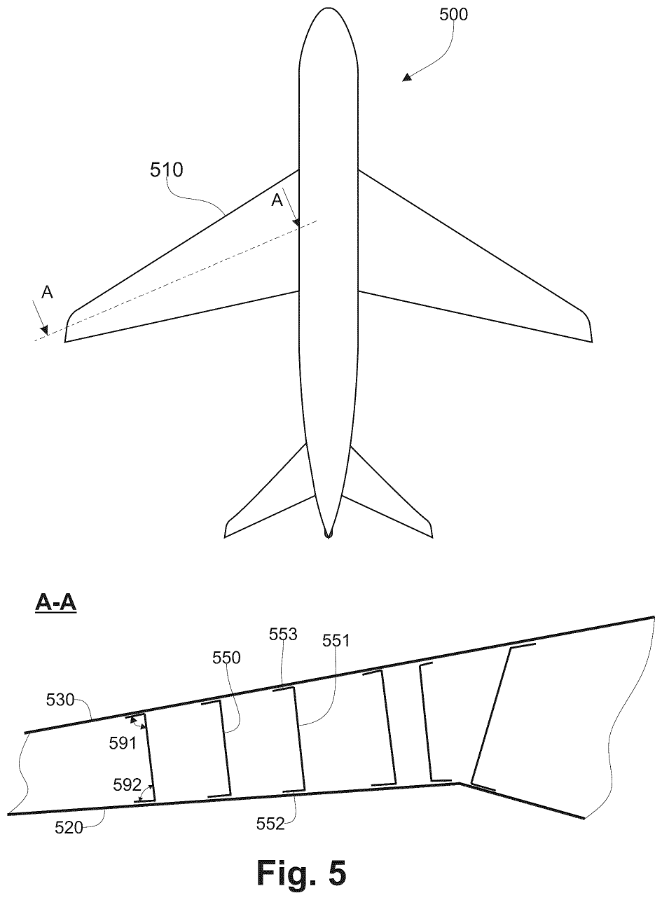

As a non-limiting example, [FIG. 5], the wing (510) of an aircraft (500), comprises a plurality of ribs (550) extending between the intrados (520) and the extrados (530).

These ribs are shaped as parts with flanged edges, comprising a web (551) and soles (552, 553) said soles being actually flanged edges relative to the web and ensuring the junction of said ribs with the skins of the wing, on the intrados and the extrados sides.

Due to the section of the wing that narrows to its end and widens towards its connection with the fuselage, some of these ribs, in order to be connected to the skins, must have flanged edges with a pinch, that is to say that at least one of the angles (591, 592) between the web (551) and the flanges (552, 552) of the rib is less than 90°.

According to prior art, these ribs are made by assembling a specific component in lieu of at least one of the flanged edges.

The use of the tooling makes it possible to produce these parts in one piece, i.e. without any added part, directly by stamping.

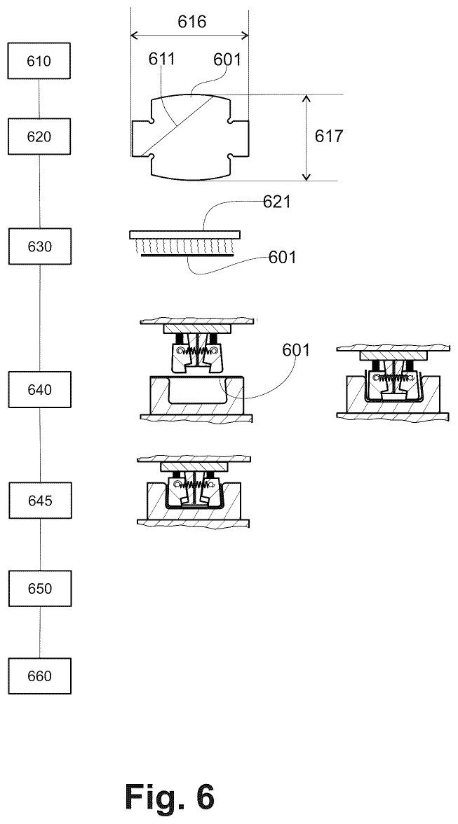

Thus, [FIG. 6], according to some embodiment, a method implements the tooling for stamping of a composite blank with a thermoplastic polymer matrix and continuous fibrous reinforcement.

The finished part to be obtained is for example a wing rib, comprising a web and at least two flanged edges making soles, at least one of said soles extending in a direction forming an angle less than 90° with respect to the web.

According to an adjustment step (610), the punch is adjusted, in particular by means of the peelable shims, between the two parts of the central part so that the airgap between the imprint and the various parts of the punch at the end of the press strike stroke is adapted to the targeted thicknesses of the part.

According to a step of blank procurement (620), a composite blank (601) intended to be formed by the method is obtained by means of techniques known of the prior art. The composite blank comprises a thermoplastic polymer matrix characterized in particular by a melting temperature, and, if relevant, by a crystallization temperature or a glass transition temperature depending on the nature of the polymer. By way of non-exhaustive examples, for aeronautical applications, that polymer is a polyetheretherketone (PEEK), a polyetherketone ketone (PEKK), a polyetherimide (PEI) or a phenylene polysulphide (PPS).

The blank is reinforced by continuous reinforcement fibers (611), i.e. extending continuously between two edges of the blank (601), made of glass, carbon or aramid, alone or in combination, without these examples being exhaustive. These fibers have the particularity of not exhibiting plasticity at the temperatures of use of the part as well as at the temperatures of implementation of the method.

The blank is obtained by techniques known from the prior art. It is obtained, for example, by high-pressure waterjet cutting in a pre-consolidated composite plate, or by a process as described in document EP 3 096 940.

The blank thus obtained is flat and rigid.

In a heating step (630), the blank is heated to a temperature equal to or greater than the melting temperature of the polymer matrix. For this purpose and according to an exemplary embodiment, the blank is transported on a polyimide sheet or in a tool as described in document EP 3 065 931 under an infrared radiant panel (621) and heated in the open air to this temperature.

In a stamping step (640), the hot blank (601) is placed on the forming die while the punch is moved away from it. 3096940

A width of the blank (616, 617) is, in all directions, greater than the width of the opening (116) of the imprint, so that the blank (601) rests on the edges of the forming die and can only conform to the shapes of the imprint if it is pushed into the imprint and deformed by the punch.

Then, the punch is moved towards the forming die so as to deform the blank. This deformation is possible by the relative slipping of the continuous fibers of the composite in the polymer matrix heated to a temperature where it offers almost no resistance to this relative displacement, the blank having been deconsolidated during the heating stage and also de-compacted during this first stamping phase.

During a compaction stage (645), which is carried out in continuity with the stamping phase, when the striking stroke wedges the bottom of the part, which will make the web, between the end of the punch and the bottom of the imprint under a certain pressure, which depends on the characteristics of the compression springs (130 [FIG. 1]) between the punch and the moving platen. The continued stroke of the moving platen of the press produces the lateral expansion of the punch, which has the effect of compacting the flanged edges between the side walls of the imprint and the movable lateral parts of the punch.

The compaction eliminates voids between fibers ensuring a uniform distribution of fibers and matrix throughout the whole thickness of the part.

During a consolidation step (650) the part is cooled down while maintaining the pressure in the tooling, i.e. without moving the moving platen of the press compared to the previous step, until the part reaches a temperature suitable for its unmolding. To this end, according to unrepresented embodiments, the die may include heating and cooling means for a better temperature control during the different stages.

During an unmolding step (660), the moving platen is moved away from the forming die and the part is unmolded.

The part is then routed by water jet or milling so as to remove uncompacted edges.

The above specification and the examples of embodiment show that the invention achieves the intended purpose and allows the making of a part with pinched flanged edges by stamping in particular of a composite blank with continuous fibrous reinforcement, while providing a precise control of the thicknesses of both the web and the flanged edges. Of course, the tooling and the method described are also adapted to the making of a part with non-pinching flanged edges, or even with flaring flanged edges. In the latter case, the mobilities provide increased control of thicknesses of both the web and the flanged edges, and consequently achieve an improved quality of the part in terms of material integrity.

1-5. (canceled)

6. A method for making a composite part comprising a thermoplastic polymer matrix and comprising a web and at least two first flanged edges, at least one of the first flanged edges being oriented with respect to the web at an angle of less than 90°, the method implementing a tooling comprising:
a press comprising a fixed platen and a moving platen configured to move toward the fixed platen in a striking direction;
a die, set on the fixed platen, comprising an imprint comprising an opening with an entry width, a bottom and side walls;
a punch attached to moving platen, comprising a central part and at least two movable lateral parts in sliding connection with the central part which comprises a wedge-shaped end between the at leas two movable lateral parts, a spring urging the at least two movable lateral parts against the central part, configured so that a free width of the punch is less than the entry width and so that when the at least two movable lateral parts are stopped in translation in against the bottom of the die in the striking direction, a further displacement of the central part in the striking direction relative to the at least two movable lateral parts causes a lateral expansion of the punch and an expanded width of the punch equal to or greater than the entry width;
the method comprising the steps of:
obtaining a composite blank with a width greater than the entry width;
heating the composite blank at a temperature equal to or higher than a melting temperature of the thermoplastic polymer matrix;
positioning the composite blank over the opening;
stamping the composite blank between the punch and the imprint according to a stroke in the striking direction until the at least two movable lateral parts reach a distance from the bottom of the imprint equal to the thickness of the web;
pursuing the stroke of the punch for causing the lateral expansion of the punch until the expanded with is comprised in a distance from the side walls equal to the thickness of the first flanged edges;
cooling down the part while under pressure between the punch and the imprint to a temperature lower than the melting temperature of the polymer matrix; and
moving the punch away from the die and removing the part from the die.

7. The method of claim 1, wherein the wedge-shaped end of the punch comprises two end parts with adjustable shims between the two end parts and wherein the method comprises a step of:
pairing the punch and the imprint by adjusting a thickness of the adjustable shims according to a thickness of the web and a thickness of the flanged edges.

8. The method of claim 1, wherein the composite part further comprises two second flanged edges, at least one of the second flanged edges being oriented with respect to the web at an angle of less than 90°, the punch further comprises two additional movable lateral parts in sliding connection with the central part which further comprises a second wedge-shaped end between the additional movable lateral parts, enabling a second lateral expansion of the punch, and wherein the step of pursuing the stroke of the punch for causing the lateral expansion of the punch is performed until the expanded width is comprised in a distance from the side walls equal to the thickness of the first and the second flanged edges.

9. The method of claim 1, wherein the polymer matrix is selected among a polyetheretherketone (PEEK), a polyetherketone ketone (PEKK), a polyetherimide (PEI) and a phenylene polysulphide (PPS).
